(19) United States
(12) Patent Application Publication
(10) Pub. No.: US 2005/0062753 A1
(43) Pub. Date: Mar. 24, 2005

(54) Color control system and color control method

(75) Inventor: Shigeyuki Kitazawa, Kawaguchi-shi (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Medical & Graphic, Inc., Tokyo (JP)

(21) Appl. No.: 10/939,833

(22) Filed: Sep. 13, 2004

(30) Foreign Application Priority Data
Sep. 19, 2003 (JP) JP2003-329143

(51) Int. Cl. G09G 5/02

(52) U.S. Cl. 345/589

(57) ABSTRACT

A color control system for a plurality of image outputting apparatuses individually installed at each site, for providing information regarding a corrected measured value of an output material from each image outputting apparatuses, the corrected measured value being obtained based on a standard value. The color control system including: a plurality of terminal apparatuses, being installed at each site and having a measured value transmission section; and a control server connected to the terminal apparatuses via a network. The control server including: a measured value storage section for storing a standard value of the color sample; a measured value receiving section; a correction formula deriving section; and an information generating section for creating information about a change over time of the corrected measured value, so that the corrected measured value of the output material can be browsed from each terminal apparatus.

### BACKGROUND OF THE INVENTION

The present invention relates to a color control system and its color control method for executing the color control of a plurality of image output apparatuses, individually installed at each site, by deriving a correction formula from both the value measured by a calorimeter, which is located at each site so as to measure an object outputted by the aforementioned image output apparatus, and the standard value, and correcting the difference between the value measured by the calorimeter at each site and the standard value according to the derived correction formula, and providing information about the measured values of the outputted object. The present invention also relates to for the aforementioned color control system.

For example, there is an output apparatus such as a color-proof forming apparatus for outputting a color proof to verify finish of the printed matter in advance. With regard to such an output apparatus, it is sometimes required that output apparatuses installed in a plurality of remote sites should output objects with the same level of finish so as to calibrate colors of the color proof to be outputted.

In this case, it is necessary to carry out color control, specifically calibration, of those output apparatuses in order to equalize color and density of the objects outputted by the output apparatuses on the sites.

To do so, at each site, first, a calorimeter (e.g. color difference gauge) measures color and density (e.g. values L*, a*, and b* in the CIE L*a*b* color system and X, Y, Z tristimulus values in the XYZ color system) of the object outputted by an output apparatus. Then, the color value and density value of the object outputted by the output apparatus are adjusted so as to approximate each measured value to the standard value according to the difference between the measured value and the standard value.

There is a similar apparatus. For example, Published Unexamined Japanese Patent Application No. Hei 10-315436 discloses a printed-matter quality control apparatus (see patent document 1) for evaluating the difference between the color and density of the outputted printed matter and the color and density of the standard printed matter. In this printed-matter quality control apparatus, first, a piece of standard printed matter is placed on the document platen, and color at each measuring point is measured by a calorimeter, and next, a piece of examined printed matter is placed on the document platen and the color at the location which corresponds to each measuring point on the standard printed matter is measured by the calorimeter. Then, the difference between both values is computed by a computer, and expressed as values L*, a*, and b* in the CIE L*a*b* color system. -The calculation result is then compared with the predetermined standard value of the evaluation criteria, and finally evaluation is automatically carried out. Accordingly, the aforementioned printed-matter quality control apparatus enables anyone to easily control quality of the printed matter without requiring skills and experiences.

[Patent document 1] Published Unexamined Japanese Patent Application No. Hei 10-315436 (paragraphs [0011] to [0039], FIGS. 1 through 5)

However, each site's calorimeter usually has individual difference. Therefore, even when calorimeters of the same model which conforms to the aforementioned printed-matter quality control apparatus are used, individual difference of the apparatuses causes a problem in that the values measured by the apparatuses are not always the same.

Under those circumstances, although the color and density values of an object outputted by an output apparatus at each site are measured by a calorimeter and the values are adjusted based on the measured values, it is difficult to properly calibrate the output apparatus located at each site because differences of measured values among the sites have not been corrected.

Furthermore, color and density of the object outputted by the output apparatus are affected by the ambient temperature and humidity. Therefore, it is important to control such changes over time in order to properly adjust the color and density values outputted by the image output apparatus according to the measured values. However, to carry out such a control at each site, it is necessary to periodically measure the color and density of the outputted object at each site and record the difference between the measured value and the standard value every time. This results in troublesome tasks.

In the light of the above circumstances, an objective of the present invention is to provide a color control system and its color control method for executing the color control of a plurality of image output apparatuses, individually installed at each site, by deriving a correction formula from both the value measured by a calorimeter, which is located at each site so as to measure an object outputted by the aforementioned image output apparatus, and the standard value, and correcting the difference between the value measured by the calorimeter at each site and the standard value according to the derived correction formula, and providing information about the measured values of the outputted object showing changes over time of the measured values.

### SUMMARY OF THE INVENTION

The above problem can be solved by the following:

(1) A color control system for executing the color control of a plurality of image output apparatuses, individually installed at each site, by providing information about a corrected measured value of an object outputted by said image output apparatus installed at each site, the value having been measured by each calorimeter and corrected according to said measured value and the standard value, comprising
a plurality of terminal apparatuses having a measured value transmission means for transmitting a value of a color sample measured by said calorimeter installed at each site, a value of the outputted object measured subsequently, and a measurement date; and
a control server connected to said plurality of terminal apparatuses via a network having
a measured value storage means for storing a value of said color sample measured by a standard calorimeter in advance as the standard value;
a measured value receiving means for receiving a measured value of the color sample, a measured value of the outputted object, and the measurement date transmitted from said measured value transmission means;
a correction formula deriving means for deriving a correction formula according to said received measured value of the color sample and said stored standard value in order to correct said received measured value of the color sample by approximating the value to said stored standard value; and
an information generation means for creating information about the change over time of the corrected measured value of the outputted object based on the corrected measured value of the outputted object which has been received and corrected by said derived correction formula and the measurement date, so that said corrected measured value of the outputted object can be browsed from said terminal apparatus.

(2) A color control method for executing the color control of a plurality of image output apparatuses, individually installed at each site, by providing information about a corrected measured value of an object outputted by said image output apparatus installed at each site, the value having been measured by each calorimeter and corrected according to said measured value and the standard value, comprising the step of:
(a) transmitting a value of a color sample measured by said calorimeter, a value of the outputted object measured subsequently, and a measurement date in a plurality of terminal apparatuses individually installed at each site; and in a control server connected to said plurality of terminal apparatuses via a network,
(b) storing a value of said color sample measured by a standard calorimeter in advance as the standard value;
(c) receiving a-measured value of the color sample, a measured value of the outputted object, and the measurement date transmitted in said measured value transmission step;
(d) deriving a correction formula according to said received measured value of the color sample and said stored standard value in order to correct said received measured value of the color sample by approximating the value to said stored standard value; and
(e) creating information about the change over time of the corrected measured value of the outputted object based on the corrected measured value of the outputted object which has been received and corrected by said derived correction formula and the measurement date, so that said corrected measured value of the outputted object can be browsed from said terminal apparatus.

According to a color control system and color control method therefor in accordance with the present invention, a difference between the value measured by a calorimeter installed at each site and the standard value is corrected according to a correction formula derived from the value measured by a colorimeter installed at each site and the standard value, and the change over time of the measured values of the outputted object is displayed, so that the values can be browsed. Therefore, by browsing the data, a user can efficiently manage change over time of the output color values and output density values of the image output apparatus installed at the user's site. Furthermore, by adjusting the output color value and output density value of the output apparatus installed at the user's site according to the display contents, it is possible to carry out proper color control.

Furthermore, according to a color control system and color control method thereof in accordance with the present invention, a user can browse the change over time of the output color values and output density values of the image output apparatus installed at the user's site from a terminal apparatus installed at the user's site. Accordingly, a user can confirm the contents without going to the location at which the control server is located. As a result, it is possible to efficiently manage change over time of the output color values and output density values of the image output apparatus installed at the user's site.

### BRIEF DESCRIPTION OF THE DRAWINGS

FIG. 1 is an explanatory drawing showing the configuration of a color control system according to the present invention.

FIG. 2 is an explanatory drawing showing the configuration of a color chart for calorimeter correction.

FIG. 3 is a diagram showing the configuration of the color chart measurement screen for correction which is displayed on the display means of a terminal apparatus in the color control system shown in FIG. 1.

FIG. 4(a) is a flow chart showing a series of operations of the color control method conducted by the calorimeter and the terminal apparatus in the color control system shown in FIG. 1. FIG. 4(b) is a flow chart showing a series of operations of the color control method conducted by the control server in the color control system shown in FIG. 1.

FIG. 5 is a flow chart showing a series of operations of the color control method conducted by the control server in the color control system shown in FIG. 1.

FIG. 6 is a diagram showing the configuration of the diagnosis screen which displays results calculated by the calculation section in the color control system shown in FIG. 1.

FIG. 7(a) is a diagram showing a display format of the evaluation report screen created by the information generation section in the color control system shown in FIG. 1. FIG. 7(b) is a diagram showing another display format of the evaluation report screen created by the information generation section in the color control system shown in FIG. 1.

FIG. 8(a) is a diagram showing a graph display format that appears in the graph box on the evaluation report screen shown in FIG. 7(b). FIG. 8(b) is a diagram showing another graph display format that appears in the graph box on the evaluation report screen shown in FIG. 7(b).

FIG. 9(a) is another diagram showing a graph display format that appears in the graph box on the evaluation report screen shown in FIG. 7(b). FIG. 9(b) is another diagram showing another graph display format that appears in the graph box on the evaluation report screen shown in FIG. 7(b).

### DETAILED DESCRIPTION OF THE PREFERRED EMBODIMENT

Hereafter, a preferred embodiment of a color control system and color control method thereof according to the present invention will be specifically explained with reference to the drawings.

### Configuration of the Color Control System

First, configuration of the color control system in this embodiment will be described in detail with reference to the drawings.

(Schematic Configuration of the System)

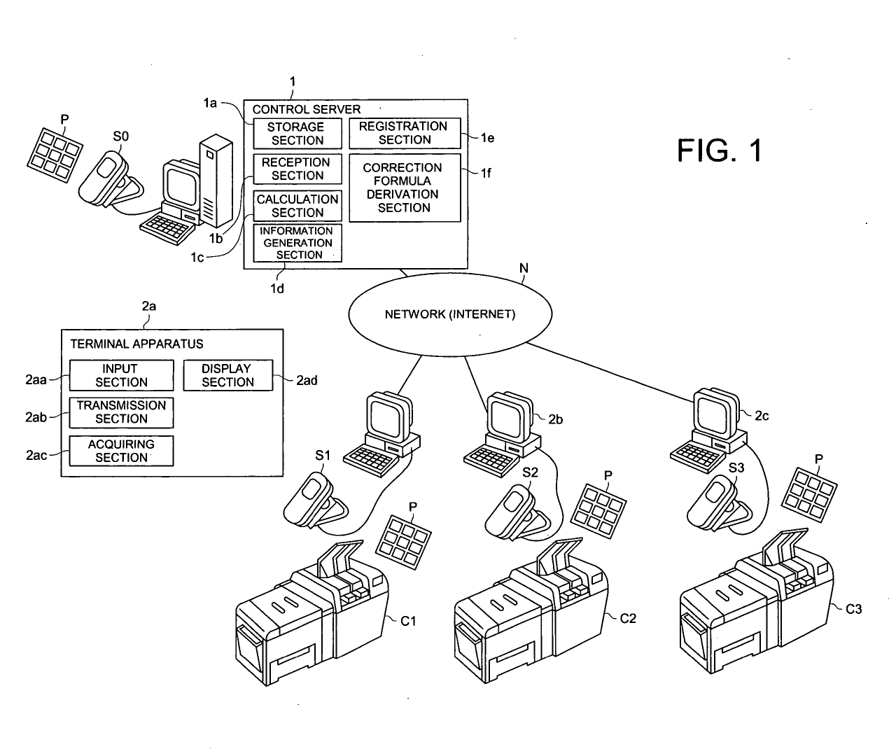

FIG. 1 shows the configuration of the aforementioned color control system. As shown in FIG. 1, the color control system roughly consists of a control server 1 and a plurality of terminal apparatuses 2a through 2c. Specifically, first, color and density of an object outputted by each output apparatus C1 through C3 located at a plurality of remote sites are measured by each calorimeter S1 through S3, and the control server 1 calculates the difference between the value measured by a calorimeter S1 through S3 and the value measured by the standard calorimeter SO (hereafter, referred to as standard value), and derives a correction formula from those measured values to correct and approximate the value measured by each calorimeter S through S3 to the standard value, and then displays, on the Web page, the change over time of the corrected measured values, of the object outputted by each output apparatus C1 through C3, which have been measured by a calorimeter S1 through S3 and corrected according to the aforementioned correction formula. A terminal apparatus 2a through 2c is provided for each colorimeter S1 through S3, and each terminal apparatus 2a through 2c transmits the value measured by a corresponding calorimeter S1 through S3 to the control server 1 and also displays the aforementioned Web page to be browsed.

Any number of terminal apparatuses 2a through 2c can be disposed according to the number of calorimeters S1 through S3. Those output apparatuses C1 through C3 and calorimeters S1 through S3 can be different products or models. Furthermore, the output apparatus C1 through C3 can be a printer, copier, etc., other than the color-proof forming apparatus provided that the apparatus can adjust color and density of an outputted object and particularly color and density of the outputted object change over time.

(Detailed Configuration of the Control Server)

Detailed configuration of the control server 1 will be described. The control server 1 is a computer terminal, and roughly consists of a display means such as a monitor, input means such as a keyboard, mouse, and the server main body. The server main body consists of a storage section 1a, reception section 1b, calculation section 1c, correction formula derivation section 1f, information generation section 1d, and registration section 1e. The storage section 1a stores the standard values, in advance, which are the measured values of color and density of the color chart P for calorimeter correction that have been measured by the standard calorimeter S0. The reception section 1b receives the measured values of the color and density of the color chart P for calorimeter correction which have been measured by the calorimeter S1 through S3 and transmitted by the terminal apparatus 2a through 2c, and also receives the measured values and the measurement date of the color and density of the object outputted by the output apparatus C1 through C3 which have been measured by the calorimeter S1 through S3 and transmitted by the terminal apparatus 2a through 2c. The calculation section 1c calculates the difference between the measured value of the color and density of the color chart P for calorimeter correction, which has been measured by the calorimeter S1 through S3 and received by the reception section 1b, and the standard value of the color and density of the color chart P for calorimeter correction stored in the storage section 1a. The correction formula derivation section 1f derives a correction formula from the measured value of the color and density of the color chart P for calorimeter correction, which has been measured by the calorimeter S1 through S3 and received by the reception section 1b, and the standard value of the color and density of the color chart P for calorimeter correction stored in the storage section 1a so as to correct and approximate the aforementioned measured value to the aforementioned standard value. Then, the information generation section 1d corrects the measured value of the color and density of the object outputted by the output apparatus C1 through C3, which has been measured by the calorimeter S1 through S3 and received by the reception section 1b, according to the correction formula derived by the correction formula derivation section 1f, and based on the corrected measured value and the measurement date, the information generation section 1d creates evaluation report screens 30A and 30B which are Web pages (described later) that display information about the change over time of the aforementioned corrected measured values. The registration section 1e executes database authentication of a user who is using the terminal apparatus 2a when the acquiring section 2ac of the terminal apparatus 2a (described later) accesses the control server 1 by means of a Web browser in order to acquire the evaluation report screens 30A and 30B which are Web pages.

The storage section 1a corresponds to a “measured value storage means” of the present invention and consists of a computing means such as CPU, and a storage means such as memory, wherein the computing means executes a prescribed calculation program stored in the storage means thereby carrying out a correction procedure (described later). The reception section 1b corresponds to a “measured value receiving means” of the present invention and is configured by network I/F. The calculation section 1c consists of a computing means such as CPU, and a storage means such as memory, wherein the computing means executes a prescribed calculation program stored in the storage means thereby carrying out a calculation procedure (described later). The correction formula derivation section 1f corresponds to a “correction formula deriving means” of the present invention, and consists of a computing means such as CPU, and a storage means such as memory, wherein the computing means executes a prescribed calculation program stored in the storage means thereby carrying out a correction formula derivation procedure (described later). The information generation section 1d corresponds to an “information generation means” of the present invention, and consists of a computing means such as CPU, and a storage means such as memory, wherein the computing means executes a prescribed calculation program stored in the storage means thereby carrying out a information generation procedure (described later). The registration section 1e consists of a computing means such as CPU and a storage means such as memory, wherein the computing means executes a prescribed calculation program stored in the storage means thereby carrying out a user authentication procedure (described later).

(Configuration of the Color Chart for Calorimeter Correction)

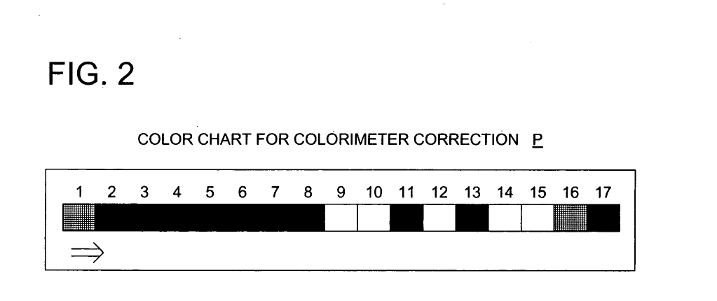

Configuration of the aforementioned color chart P for calorimeter correction will be explained. The color chart P for calorimeter correction corresponds to a “color sample” of the present invention, and specifically, as shown in FIG. 2, colors, such as C 100%, M 100%, Y 100%, K 100%, CMY 100%, MY 100% etc., are arranged in line, and each color functions as a measuring point (17 measuring points are provided in FIG. 2). That is, the standard calorimeter S0 and other calorimeters S1 through S3 measure those measuring points in the same sequential order (e.g. in the arrow direction in the drawing).

It is preferable that the color chart P for calorimeter correction be made by a heatmelt-type high-end DDCP (i.e. the Direct Digital Color Proof system which outputs superfine digital data directly to a printer) in which color does not change much over time.

(Detailed Configuration of the Terminal Apparatus)

Detailed configuration of the terminal apparatus 2a through 2c will be explained. However, configuration of the terminal apparatus 2a through 2c is the same. Therefore, an explanation will be given only about a terminal apparatus 2a.

A terminal apparatus 2a is a computer terminal, and roughly consists of an input means such as a keyboard, mouse, and an apparatus main body including the computer. Furthermore, the terminal apparatus 2a specifically consists of an input section 2aa, transmission section 2ab, acquiring section 2ac, and display section 2ad. The input section 2aa is an interface for inputting values of the color and density of the color chart P for calorimeter correction measured by a calorimeter S1 as well as values of the color and density of the object outputted by the output apparatus C1 which have been measured by the calorimeter S1. The transmission section 2ab transmits the value measured by the calorimeter S1 and inputted via the input section 2aa to the control server 1 via network N. The acquiring section 2ac acquires, by means of a Web browser, evaluation report screens 30A and 30B (described later) which have been created as Web pages by the information generation section 1d in the control server 1. The display section 2ad displays the evaluation report screens 30A and 30B acquired by the acquiring section 2ac.

Moreover, the input section 2aa is configured by communication I/F. The transmission section 2ab corresponds to a “measured value transmission means” of the present invention and is configured by network I/F. The acquiring section 2ac corresponds to an “acquisition means” of the present invention, and consists of a computing means such as CPU, and a storage means such as memory, so that the acquiring section 2ac acquires evaluation report screens 30A and 30B, which are Web pages, by means of a Web browser. The display section 2ad corresponds to a “display means” of the present invention and is configured by a display means such as a monitor.

[Color Control Method]

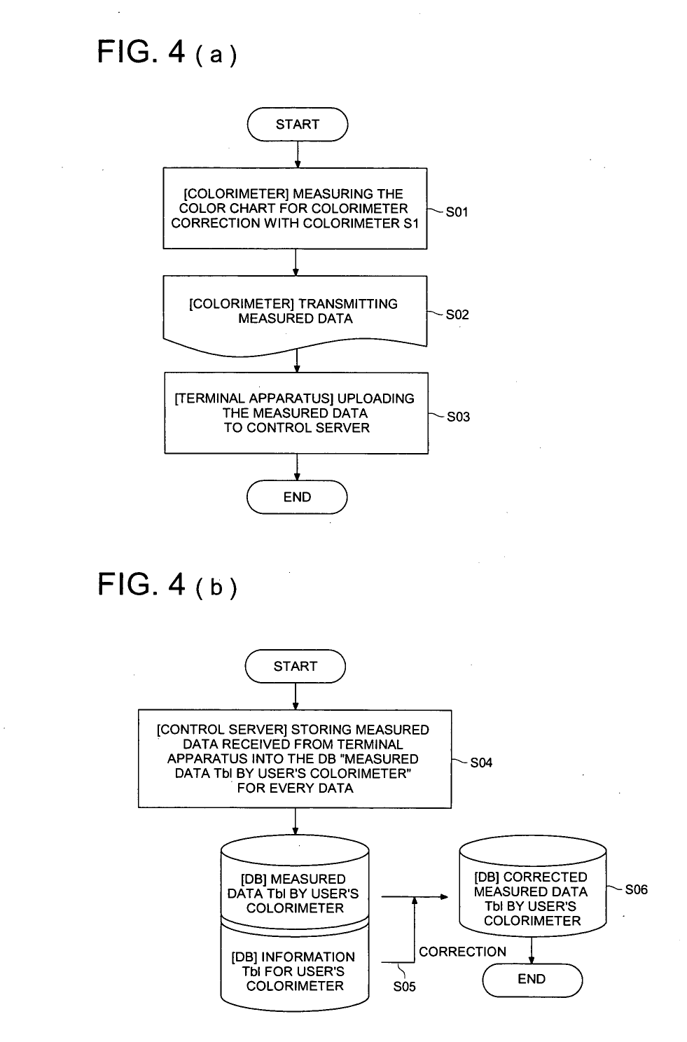

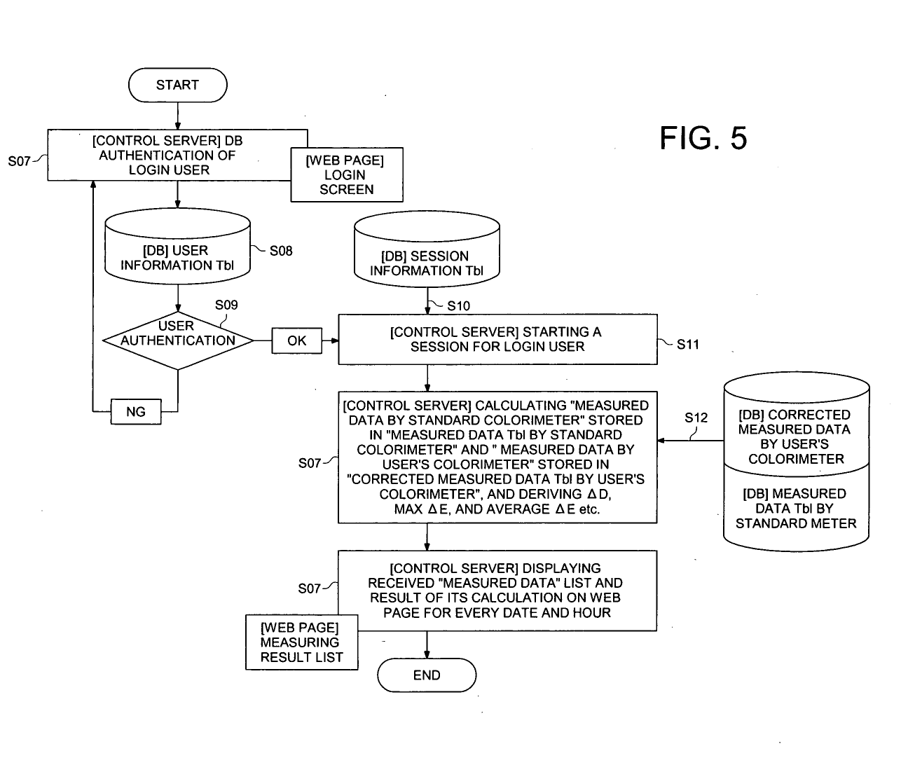

The color control method executed in the aforementioned color control system will be explained according to the flow chart shown in FIGS. 4 and 5. Hereafter, an example will be shown about the case in which values measured by a colorimeter S1 are corrected and information about change over time of the measured values of color and density of the object outputted by an output apparatus C1 is provided on Web pages.

In advance, an administrator who administrates the control server la uses a calorimeter S0 to measure the color and density of the aforementioned color chart P for calorimeter correction at the prescribed measuring points according to the prescribed sequential order so as to obtain the standard values.

[Measured Value Storing Step]

Next, the administrator inputs the standard values of color and density of the color chart P for calorimeter correction measured by the standard calorimeter S0 by using an input means such as a keyboard, mouse, located in the control server 1 or by registering a file which stores the standard values. At this point, information about measuring points of the color chart P for calorimeter correction and sequential measurement order is also entered. By doing so, the measured values of color and density of the color chart P for calorimeter correction are stored, together with the information about measuring points and measurement order, in the measured data table by standard calorimeter (described later) in the storage section 1a as data measured by standard calorimeter.

On the other hand, a user who uses the aforementioned color control system first carries out operations necessary for the registration of values measured by a colorimeter S1 in the terminal apparatus 2a. Specifically, the user accesses the control server 1 from the terminal apparatus 2a, and on the input screen displayed on the Web page, the user enters prescribed items, specifically, information about the mailing address (i.e. user's address, name, telephone number, etc.) to which the color chart P for calorimeter correction to be used for measurement by calorimeter S1 will be sent.

The administrator browses the input screen, which is the aforementioned Web page, in the control server 1, checks the prescribed items, and sends the color chart P for calorimeter correction to the specified mailing address.

After the color chart P for calorimeter correction has been sent, the user connects the calorimeter S1 to the input section 2aa of the terminal apparatus 2a via a communication means such as a communication cable, accesses the control server 1 from the terminal apparatus 2a, and downloads a measurement tool from the tool screen displayed on the Web page. The measurement tool includes information about measuring points and measurement order used for measuring the color and density of the aforementioned color chart P for calorimeter correction by using the standard calorimeter S0 as well as information about prescribed destination to which the measured values are transmitted. The aforementioned measurement tool is downloaded via the terminal apparatus 2a into the calorimeter S1, and in the calorimeter S1, color and density of the color chart P for calorimeter correction at the same measuring points as the standard calorimeter S0 are measured according to the same sequential order. Moreover, the measurement tool may be stored in a storage medium such as a CD-ROM, and then downloaded into the calorimeter S1 via the terminal apparatus 2a.

[Measured Value Transmission Step]

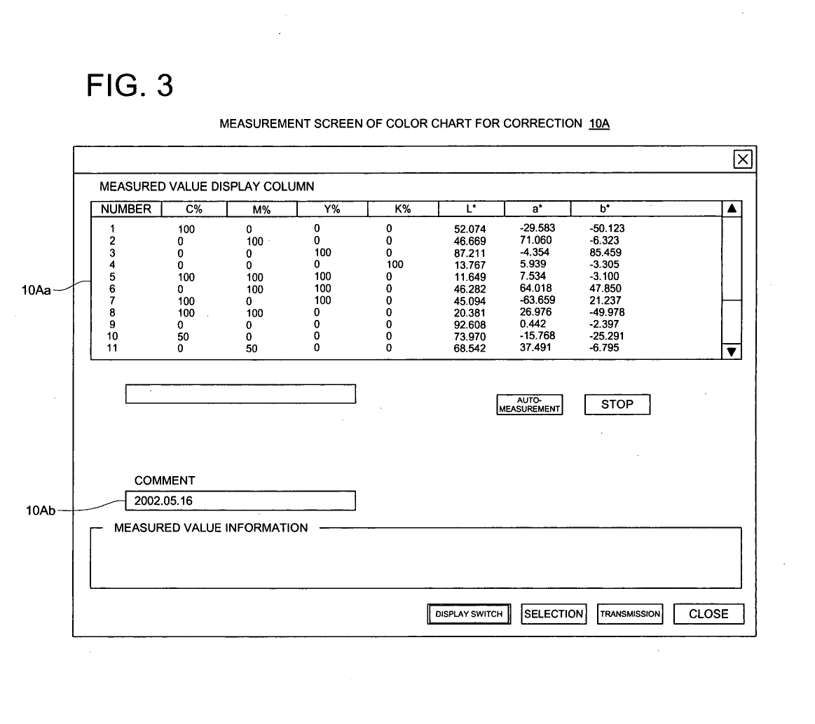

As FIG. 4(a) shows, when a user measures color and density of the color chart P for calorimeter correction by using a calorimeter S1 (S01), the value measured by the calorimeter S1 is transmitted to the terminal apparatus 2a via the input section 2aa (S02). At this point, the measured values of the color chart P for calorimeter correction at each measuring point are displayed on the measurement screen located on the display means of the terminal apparatus 2a through 2c, specifically, in the measured value display column 10Aa on the measurement screen 10A for the color chart for correction shown in FIG. 3, as values L*, a*, and b* in the CIE L*a*b* color system.

Next, the user operates the input means and selects the transmission button on the measurement screen 10A for the color chart for correction, thereby transmitting the information to the control server 1 from the transmission section 2ab of the terminal apparatus 2a (S03).

[Measured Value Receiving Step]

As FIG. 4(b) shows, in the control server 1, the reception section 1b receives measured values of the color chart P for calorimeter correction measured by the calorimeter S1 and transmitted by the transmission section 2ab of the terminal apparatus 2a, and stores the values in the measured data table by user's calorimeter located in the storage section 1a (S04). In the information table for user's calorimeter, the storage section 1a has stored correction information for correcting the difference, due to individual difference of the product or model, between the standard value measured by the standard calorimeter S0 and the value measured by calorimeters S1 through S0. The storage section 1a corrects the value of the color chart P for calorimeter correction measured by the calorimeter S1 which has been stored in the measured data table by user's calorimeter according to the correction information stored in the information table for user's calorimeter (S05). Then, the storage section 1a stores the corrected measured data by user's calorimeter which has corrected the difference, due to individual difference of the product or model, between the standard value and the value measured by the calorimeters S1 through S3 (S06).

[Measured Value Transmission Step]

After that, the user periodically measures an object outputted by the aforementioned output apparatus C1 by using a calorimeter S1. As stated above, when the user measures color and density of an object outputted by the output apparatus C1 by using calorimeter S1, the values measured by calorimeter S1 are transmitted to the terminal apparatus 2a via an input section 2aa. The measured value of the outputted object at each measuring point is displayed on the measurement screen of the display means of the terminal apparatus 2a through 2c, specifically, displayed in the measured value display column 10Aa on the measurement screen 10A for the color chart for correction, as shown in FIG. 2, as values L*, a*, and b* in the CIE L*a*b* color system.

Herein, the user uses the input means to enter the measurement date by inputting “2003, 05, 16”, for example, in the comment box 10Ab of the measurement screen 10A for the color chart for correction, and selects the transmission button, thereby transmitting the information from the transmission section 2ab of the terminal apparatus 2a to the control server 1.

[Measured Value Receiving Step]

In the control server 1, the reception section 1b receives the values of the object outputted by the output apparatus C1 which have been measured by the calorimeter S1 and transmitted by the transmission section 2ab of the terminal apparatus 2a, and stores-the measured values in the measured data table by user's calorimeter located in the storage section 1a.

As FIG. 5 shows, when a user thus periodically measures an object outputted by the aforementioned output apparatus C1 by using the calorimeter S1, transmits the measured values and measurement date to the control server 1, and operates the input means of the terminal apparatus 2a in order to browse evaluation report screens 30A and 30B, the acquiring section 2ac accesses the control server 1 by means of a Web browser, and the login screen Web page appears in the display section 2ad of the terminal apparatus 2a. Furthermore, when the user carries out a login operation on the login screen by using the input means of the terminal apparatus 2a, the registration section 1e of the control server 1 carries out database authentication of the user who has accessed the aforementioned control server 1 from the terminal apparatus 2a (S07). That is, identification information of the user who uses the terminal apparatus 2a through 2c has been stored in the registration section 1e as the user information table, and by referring to the user information table (S08), user authentication is executed (S09). If the user is authenticated at this step (S09, OK), the registration section 1e refers to the specific information stored in the session information table (S10), and start a session, according to the aforementioned specific information, with the authenticated user, that is, the acquiring section 2ac of the terminal apparatus 2a (S11).

Then, the calculation section 1c of the control server 1 refers to the measured data by standard calorimeter stored in the measured data table by standard calorimeter located in the storage section 1a as well as refers to the corrected measured data by user's calorimeter (S12), and then calculates the difference of those measured values. Specifically, value ΔD which is a density difference; values ΔL*, Δa*, and Δb* which are the differences of values L*, a*, and b* in the CIE L*a*b* color system; and value ΔE={(ΔL*)²+(Δa*)²+(Δb*)²}^{1/2} which is the color difference are calculated at each measuring point. Then, average value ΔE of all measuring points is calculated and maximum value ΔE is retrieved (S13).

[Correction Formula Deriving Step]

The correction formula derivation section 1f refers to the measured data by standard calorimeter and the corrected measured data by user's calorimeter stored in the storage section 1b, and derives a plurality of correction formulas according to the corrected measured value of the color chart P for calorimeter correction measured by calorimeter S1 and the standard value of the color chart P for calorimeter correction measured by calorimeter S0 in order to correct and approximate the aforementioned corrected measured value of the color chart P for calorimeter correction to the aforementioned standard value of the color chart P for calorimeter correction. Moreover, at this point, before deriving the plurality of correction formulas, the correction formula derivation section 1f converts the measured value expressed in the CIE's (Commission Internationale de l' Éclairage: International Commission on Illumination) L*a*b* color system into the value expressed in the XYZ (tristimulus values) color system. This is because the XYZ (tristimulus values) color system is able to express the measured value as a positive value, thereby facilitating the correction of the measured value. However, depending on the configuration of the calorimeter S1 through S3, the measured value may be calculated in the XYZ (tristimulus values) color system. In this case, the aforementioned conversion is not necessary.

(Details of the Conversion Method)

Herein, the method for converting the measured value expressed in the aforementioned CIE's (Commission Internationale de l' Éclairage: International Commission on Illumination) L*a*b* color system into the value expressed in the XYZ (tristimulus values) color system will be explained in detail.

Equations for converting the L*a*b* color system into the XYZ (tristimulus values) color system:

For example, in the case of a D50 light source (standard color temperature 5,000 K in the printing industry), the following relational expressions are formed between (L, a, b) and (X, Y, Z):
y=(L+16.0)/116.0
x=a/500.0+y
z=y−b/200.0

Herein, in the case of xs0, ys0, zs0>0.008856:
let xs0=x³
ys0=y³
zs0=z³,

in the case of xs0, ys0, zs0≦0.008856:
let xs0=[x−(16.0/116.0)]/7.787
ys0=[y−(16.0/116.0)]/7.787
zs0=[z−(16.0/116.0)]/7.787

and when those values are substituted for the following:
X=xs0×0.98072
Y=ys0×1.00000
Z=zs0×1.8225,

each X, Y and Z element is properly expressed as value L, a and b.

(Specific Example of the Computing Method) Next, a specific example of the computing method used by the aforementioned correction formula derivation section 1f will be explained.

The correction formula derivation section if derives the correction formula according to any one of the following computing methods including a computing method described in Patent Application 2003-154927 (paragraphs [0039] through [0060], FIGS. 4 through 6) for which this applicant previously applied, and a computing method disclosed in Published Unexamined Japanese Patent Application No. Hei 11-132849 (paragraphs [0015] through [0050], FIGS. 1 through 5).

Example) Method for obtaining coefficients (α, β, γ) of the quadratic function by means of regression analysis First, obtain an error between the measured value of color and density of the color chart P for calorimeter correction that has been measured by a calorimeter S2 and the measured value of color and density of the color chart P for calorimeter correction that has been measured by a calorimeter S1 for each X, Y, Z element. Assign the measured value by the calorimeter S1 to the horizontal axis and assign an error between the aforementioned measured value and the value measured by the colorimeter S2 to the vertical axis. Plot those values for each measuring point and create a graph, and calculate the approximate curve of the measurement error for each element. If let the value measured by the colorimeter S1 as Xu, Yu, and Zu, let the value measured by the calorimeter S2 as Xs, Ys and Zs, and let the error between value measured by the calorimeter S1 and the value measured by calorimeter S2 be Dx(Xu), Dy(Xu), and Dz(Zu), the approximate curve can be expressed as follows:

Part 1: in the case when the approximate curve passes through the origin
Dx(Xu)=Xs−Xu=α(Xu+β)²
Dy(Yu)=Ys−Yu=α(Xu+β)²
Dz(Zu)=Zs−Zu=α(Xu+β)²

where, α and β are coefficients for the same sample measurement.

Part 2: in the case when the approximate straight line does not always pass through the origin
Dx(Xu)=Xs−Xu=αXu²+βXu+γ
Dy(Yu)=Ys−Yu=αYu²+βYu+γ
Dz(Zu)=Zs−Zu=αZu²+βZu+γ

where, α, β and γ are coefficients for the same sample measurement.

With respect to either one of the above approximate curves, obtain values of α, β and γ for each X, Y, Z element by using the least squares method, and derive correction formulas which are the functions of Xs, Ys, and Zs that follow Xu=, Yu=, and Zu=.

[Information Generation Step]

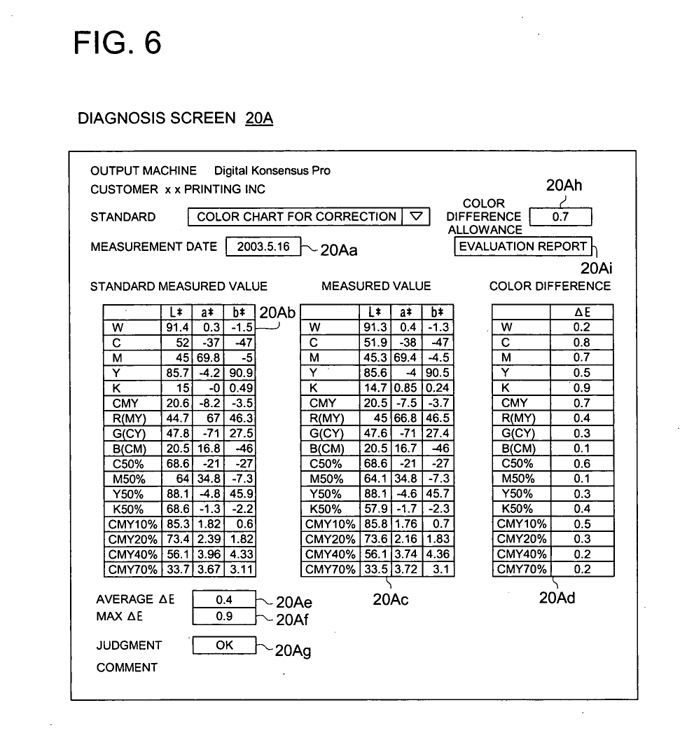

Subsequently, the information generation section 1d uses correction formulas derived by the correction formula derivation section if to correct the measured value of the object outputted by the output apparatus C1 which has been measured by the calorimeter S1 and stored in the measured data table by user's calorimeter located in the storage section 1a, and according to the aforementioned corrected measured value and the measurement date, the information generation section 1d creates information about the change over time of the aforementioned corrected measured value which is displayed on the Web page, for example, on a diagnosis screen 20A shown in FIG. 6 (S14). The diagnosis screen 20A, shown in FIG. 6, displays only information concerning the specific measurement date, and the information generation section 1d creates similar other information for each measurement date. Moreover, to create the diagnosis screen 20A, the information generation section 1d inputs information in each display column of the template on the aforementioned diagnosis screen 20A. For example, the information includes the measured value of the object outputted by an output apparatus C1 measured by calorimeter S1 (corrected value) on the standard measurement date, the measured value of the object outputted by the output apparatus C1 measured by calorimeter S1 (corrected value) on the specific measurement date, and the measurement date. Herein, a calculation program for calculating the value displayed in each display column, evaluation program for deriving evaluation results displayed in the aforementioned display column, and a retrieval program for retrieving the value displayed in the aforementioned display column are associated with each display column. With regard to the display column which displays the difference between the measured value of the object outputted by output apparatus C1 measured by the calorimeter S1 (corrected measured data) on the standard measurement date and the measured value of the object outputted by output apparatus C1 measured by the calorimeter S1 (corrected measured data) on a different measurement date, when those measured values are inputted in the aforementioned display column, the information generation section 1d (or the calculation section 1c) uses the calculation program associated with the display column to calculate the difference and displays the results. On the diagnosis screen 20A shown in FIG. 6, the measurement date is entered by inputting “2003, 05, 16” in the measurement date box 20Aa, the measured value of the object outputted by output apparatus C1 measured by the calorimeter S1 on the standard measurement date at each measuring point is inputted in the standard measured value box 20Ab, the measured value of the object outputted by output apparatus C1 measured by the calorimeter S1 on the date “2003, 05, 16” at each measuring point is inputted in the measured value box 20Ac, and the color difference value ΔE is calculated for each measuring point and displayed in the color difference box 20Ad. Furthermore, average value of ΔE at each measuring point is calculated and displayed in the average ΔE box 20Ae, and maximum value ΔE at each measuring point is retrieved and displayed in the maximum ΔE box 20Af. Furthermore, the information generation section 1d creates such information by using the aforementioned information generation method when creating an evaluation report screen (measurement result list; described later) 30A and an evaluation report screen (measurement result graph) 30B.

[Acquiring Step, Display Step]

In the terminal apparatus 2a, the acquiring section 2ac acquires the aforementioned diagnosis screen 20A by means of a Web browser, and the display section 2ad displays the screen.

[Information Generation Step]

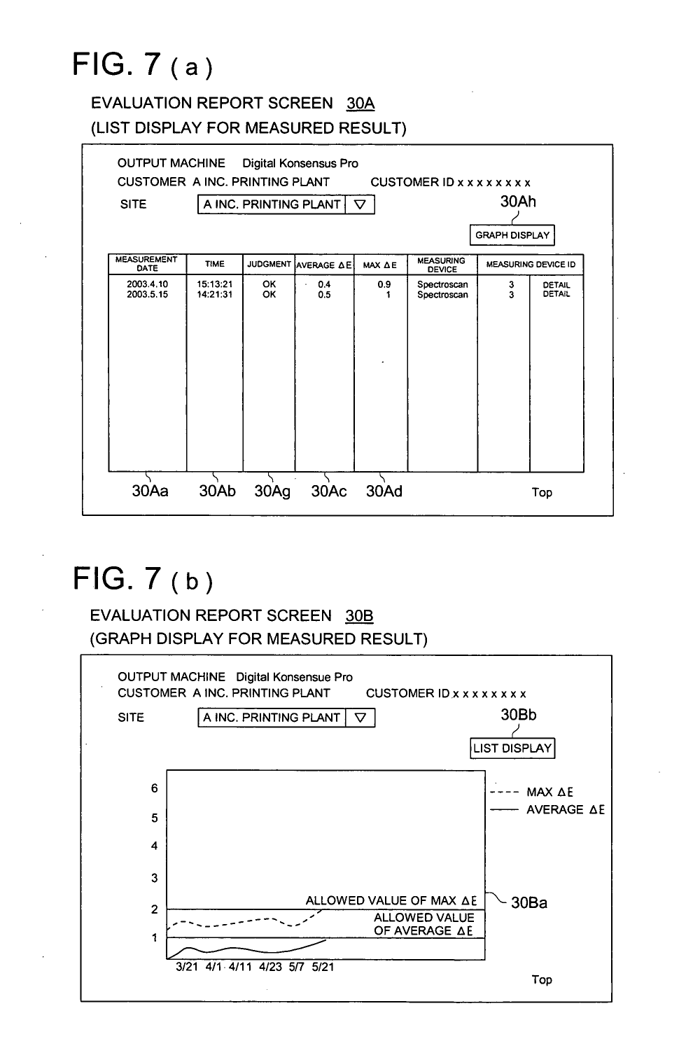

When a user operates the input means of the terminal apparatus 2a and selects evaluation report item 20Ai on the diagnosis screen 20A, the information generation section id uses the correction formula derived by the correction formula derivation section 1f to correct all of the measured values of the object outputted by an output apparatus C1 measured by calorimeter S1 which have been stored in the measured data table by user's calorimeter located in the storage section 1a, and according to the corrected measured values and the measurement date, the information generation section 1d creates information about the change over time of the aforementioned corrected measured values which will be displayed on the evaluation report screen (measurement result list) 30A shown in FIG. 7(a) or on the evaluation report screen (measurement result graph) 30B shown in FIG. 7(b) as a list or graph (S14).

[Acquiring Step, Display Step]

In the terminal apparatus 2a, the acquiring section 2ac acquires the evaluation report screen (measurement result list 30A or the evaluation report screen (measurement result graph) 30B by means of a Web browser, and the display section 2ad displays the screen.

On the evaluation report screen (measurement result list) 30A shown in FIG. 7(a), measurement dates “2003, 04, 10” and “2003, 05, 15” are displayed in the measurement date box 30Aa, measurement time “15:13:21” and “14:21:31” is displayed in the time box 30Ab, and maximum value ΔE and average value ΔE “0.4” and “0.5”, and “0.9” and “1” on each measurement date, respectively, are displayed in the average ΔE box 30Ac and the maximum ΔE box 30Ad. Furthermore, on the evaluation report screen (measurement result graph) 30B shown in FIG. 7(b), in the graph box 30Ba in which the vertical axis has the color difference and the horizontal axis has measurement date, maximum value ΔE and average value ΔE on each measurement date are plotted, and the change over time of those values are expressed as a line graph (standard measurement date is 3/21 in FIG. 7(b)).

Switching between the evaluation report screen (measurement result list) 30A shown in FIG. 7(a) and the evaluation report screen (measurement result graph) 30B shown in FIG. 7(b) is conducted by the information generation section 1d when a user operates the input means of the terminal apparatus 2a and selects the graph display item 30Ah on the evaluation report screen (measurement result list) 30A shown in FIG. 7(a) or a user operates the input means of the terminal apparatus 2a and selects the list display item 30Bb on the evaluation report screen (measurement result graph) 30B shown in FIG. 7(b).

[Display Specification Step]

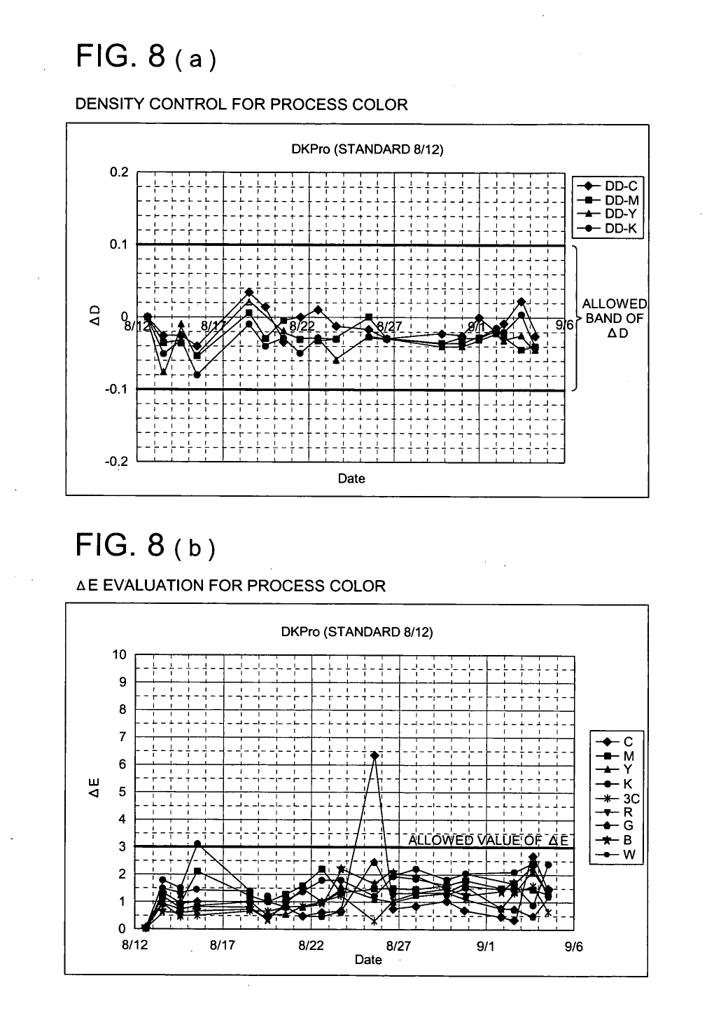

If a user operates the input means of the terminal apparatus 2a and specifies a prescribed item associated with the expression form in order to change the expression form of the vertical axis in the graph box 30Ba on the evaluation report screen (measurement result graph) 30B shown in FIG. 7(b), the information generation section 1d conducts the procedure to switch to the specified expression form of the vertical axis in the graph box 30Ba. Alternatively, at this point, the information generation section 1d creates a graph in advance in which the vertical axis has value ΔD which is density difference between the measured date and the standard measurement date (e.g. date on which the output density value or output color value was adjusted in the output apparatus C1), or has values ΔL*, Δa* and Δb* which are differences of values L*, a*, and b* in the CIE L*a*b* color system, or has value ΔE={(ΔL*)²+(Δa*)²+(Δb*)²}^{1/2} which is a color difference, and then can simply switch the display. It is also possible for the information generation section 1d to create a graph every time in accordance with the expression form and switches the display. For example, to carry out density control of the process color (Y, M, C, K), a user switches the expression form of the vertical axis to ΔD, as shown in FIG. 8(a), which indicates density difference. By doing so, the graph having density difference ΔD as the vertical axis and measurement date as the horizontal axis is displayed in the graph box 30Ba on the evaluation report screen (measurement result graph) 30B shown in FIG. 7(b). Furthermore, to control color difference of the process color (Y, M, C, K), a user switches the expression form of the vertical axis to ΔE, as shown in FIG. 8(b), which indicates color difference. By doing so, the graph having color difference ΔE as the vertical axis and measurement date as the horizontal axis is displayed in the graph box 30Ba on the evaluation report screen (measurement result graph) 30B shown in FIG. 7 (b). Moreover, the input means corresponds to a “display specification means” of the present invention.

Other than the aforementioned example, the expression form of the vertical axis of the graph box 30Ba on the evaluation report screen (measurement result graph) 30B shown in FIG. 7(b) can be changed to values ΔL*, Δa*, Δb* which are differences L*, a*, and b* in the CIE L*a*b* color system between the measurement date and the standard measurement date. Also, a plurality of graphs with different expression forms can be simultaneously displayed.

[Allowed Band/Allowed Value Specification Step]

In FIG. 6, for a user to easily judge whether or not the adjustment of the output density value or output color value of the output apparatus C1 is necessary by looking at the graph box 30Ba on the evaluation report screen (measurement result graph) 30B shown in FIG. 7(b), if a user operates the input means of the terminal apparatus 2a to specify the color difference allowance (threshold value indicating the necessity of adjustment of the output density value or output color value of the output apparatus C1) in the color difference allowance box 20Ah on the aforementioned diagnosis screen 20A, the information generation section 1d adds the allowed values of maximum value ΔE and average value ΔE as lines to the graph displayed in the graph box 30Ba on the evaluation report screen (measurement result graph) 30B shown in FIG. 7(b). Similarly, if a user specifies the color difference allowance in the color difference allowance box 20Ah on the diagnosis screen 20A, the information generation section 1d adds the allowed value of value ΔE as a line to the graph shown in FIG. 8(b). Furthermore, if a user specifies the allowed density band in the allowed density band box (also functions as a color difference allowance box 20A) on the diagnosis screen 20A, the information generation section 1d adds the allowed band of value ΔD as a line to the graph shown in FIG. 8(a). By doing so, a user can easily judge whether or not the adjustment of the output density value or output color value of the output apparatus C1 is necessary. The input means corresponds to the “allowed band/allowed value setting means” of the present invention.

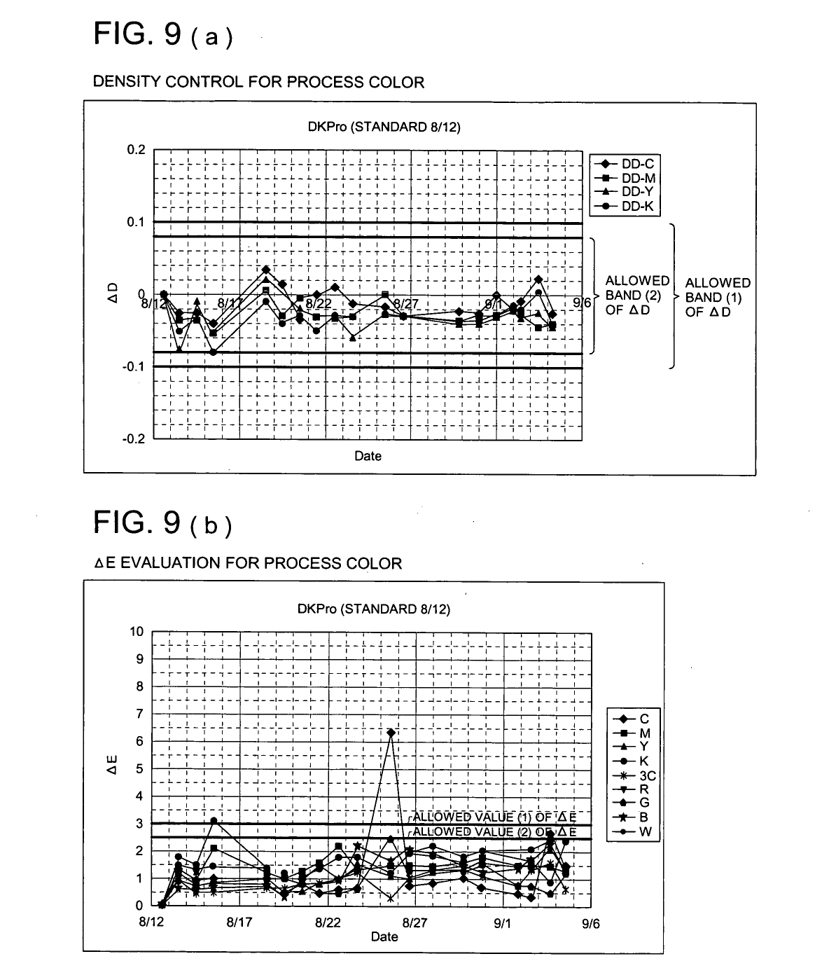

FIG. 9(a) shows another display format where two steps of the allowed density band (allowed band (1) and allowed band (2) of ΔD) are displayed. Here, when ΔD becomes greater than allowed band (2), user needs to be careful. And when ΔD becomes greater than allowed band (1), adjustment of the output density value or output color value of the output apparatus C1 is necessary.

FIG. 9(b) shows another display format where two steps of the allowed value of ΔE (allowed value (1) and allowed value (2) of ΔE) are displayed. Here, when ΔE becomes greater than allowed value (2), user needs to be careful. And when ΔE becomes greater than allowed vale (1), adjustment of the output density value or output color value of the output apparatus C1 is necessary.

By displaying graphs with two steps of allowed density band or allowed value of ΔE, user can previously be aware of needing to be careful before the time when adjustment of the output apparatus becomes necessary, and the user can prepare for the adjustment of the output apparatus C1 to conduct the adjustment efficiently.

As stated above, according to a color control system and color control method thereof in this embodiment, the correction formula derivation section 1f of the control server 1 derives the correction formula according to the value measured by the colorimeter S1 through S3 installed at each site and the standard value in order to correct and approximate the value measured by the calorimeter S1 through S3 installed at each site to the standard value, and the information generation section id uses the derived correction formula to generate information about change over time of the corrected measured value of the object outputted by the output apparatus C1 through C3 installed each site and show the data on the Web page. Therefore, a user can confirm the contents by individually browsing the Web page from a terminal apparatus 2a through 2c installed at each site without going to the location of the control server. Accordingly, it is possible to efficiently manage change over time of the measured values of the object outputted by the output apparatus C1 through C3 installed at the user's site. Furthermore, by adjusting the output color value or output density value of the output apparatus C1 through C3 installed at the user's site according to the display contents, it is possible to properly control colors.

The color control system and color control method thereof according to the present invention is not to be considered limited to what is described in the above embodiment, and can be embodied in a variety of forms as long as they are not departed from the concept of the present invention.

In the aforementioned embodiment, the value measured by the standard calorimeter S0 and calorimeters S1 through S3 are calculated in the CIE L*a*b* display system. However, the value measured can be calculated in the XYZ display system or the CIE L*u*v* display system.

It is preferable that the color chart P for calorimeter correction is outputted by the DCCP. However, it is also possible to output the color chart by an output apparatus such as a printer or copier.

Furthermore, the color charts P for calorimeter correction having the same color and density are distributed to the calorimeters S1 through S3 installed at a plurality of sites. However, it is possible to circulate one color chart from calorimeters S1 to S3, and it is also possible to sequentially distribute one color chart from calorimeters S1 to S3.

Moreover, the color chart P for calorimeter correction contains at least one of C, M, Y, K colors. When the color chart contains two or more colors, tone of at least one color is gradually changed, and the remaining colors should be constant.

1. A color control system for executing the color control of a plurality of image outputting apparatuses individually installed at each site, by providing information regarding a corrected measured value of an output material outputted by each of the plurality of image outputting apparatuses, the corrected measured value being obtained by correcting a measured value of the output material based on a standard value of the measured value, the measured value having been measured by each of a plurality of calorimeters installed at each site, the color control system comprising:
a plurality of terminal apparatuses, each of the plurality of terminal apparatuses being installed at each site and comprising a measured value transmission section for transmitting a measured value of a color sample measured by the calorimeter installed at each site, a measured value of the output material measured subsequently to the color sample, and a measurement date of the output material; and
a control server connected to the plurality of terminal apparatuses via a network, the control server comprising:
a measured value storage section for previously storing a measured value of the color sample measured by a standard colorimeter as a standard value;
a measured value receiving section for receiving the measured value of the color sample, the measured value of the output material, and the measurement date transmitted from the measured value transmission section;
a correction formula deriving section for deriving a correction formula according to the measured value of the color sample received and the standard value stored, in order to correct the measured value of the color sample received for approximating it to the standard value stored; and
an information generating section for creating information about a change over time of the corrected measured value of the output material based on the corrected measured value of the output material which has been received and corrected by the correction formula derived and the measurement date, so that the corrected measured value of the output material can be browsed from each of the plurality of terminal apparatuses.

2. The color control system of claim 1, wherein each of the plurality of terminal apparatuses further comprises:
an acquiring section for acquiring the information about a change over time of the corrected measured value of the output material created by the information generating section; and
a display section for displaying the information about a change over time of the corrected measured value of the output material acquired by the acquiring section.

3. The color control system of claim 1, wherein the information about a change over time of the corrected measured value of the output material is a graph showing a change over time of a density value or a colorimetric value of the corrected measured value, the graph representing the density value or the calorimetric value in a vertical axis and a measurement date in a horizontal axis.

4. The color control system of claim 3, wherein each of the terminal apparatuses further comprises an allowed band/allowed value setting section for setting an allowed band of the density value or an allowed value of the calorimetric value of the corrected measured value, and
the information generating section adds the allowed band of the density value or the allowed value of the calorimetric value on the graph representing the density value or the calorimetric value in a vertical axis and a measurement date in a horizontal axis.

5. The color control system of claim 4, wherein the allowed band/allowed value setting section sets two steps of the allowed band of the density value or two steps of the allowed value of the calorimetric value of the corrected measured value, and
the image generating section adds the two steps of allowed band of the density value or the two steps of allowed value of the calorimetric value on the graph representing the density value or the calorimetric value in a vertical axis and a measurement date in a horizontal axis.

6. The color control system of claim 11 wherein the information about a change over time of the corrected measured value of the output material is a graph showing a change over time of a density value or a calorimetric value of the corrected measured value, the graph representing the density value or the calorimetric value in a vertical axis and a measurement date in a horizontal axis, wherein
each of the plurality of terminal apparatuses further comprises a display specifying section for specifying, as the information about a change over time of the corrected measured value of the output material, one of the graph representing the density value in a vertical axis and a measurement date in a horizontal axis and the graph representing the calorimetric value in a vertical axis and a measurement date in a horizontal axis, or both of the graphs.

7. The color control system of claim 6, wherein each of the terminal apparatuses further comprises an allowed band/allowed value setting section for setting an allowed band of the density value or an allowed value of the calorimetric value of the corrected measured value, and the image generating section adds the allowed band of the density value or the allowed value of the calorimetric value on the graph representing the density value or the calorimetric value in a vertical axis and a measurement date in a horizontal axis.

8. The color control system of claim 7, wherein an allowed band/allowed value setting section sets two steps of the allowed band of the density value or two steps of the allowed value of the calorimetric value of the corrected measured value, and
the image generating section adds the two steps of allowed band of the density value or the two steps of allowed value of the colorimetric value on the graph representing the density value or the calorimetric value in a vertical axis and a measurement date in a horizontal axis.

9. The color control system of claim 3, wherein the calorimetric value comprises values of L*, a*, and b* in the CIE L*a*b* color system, and the change over time of the calorimetric value of the corrected measured value comprises values of ΔL*, Δa*, and Δb* which are the differences of the corrected measured value from the standard value of the calorimetric value, and value of ΔE expressed by ΔE={(ΔL*)²+(Δa*)²+(Δb*)²}^{1/2}.

10. The color control system of claim 6, wherein the calorimetric value comprises values of L*, a*, and b* in the CIE L*a*b* color system, and the change over time of the colorimetric value of the corrected measured value comprises values of ΔL*, Δa*, and Δb* which are the differences of the corrected measured value from the standard value of the calorimetric value, and value of ΔE expressed by ΔE=(ΔL*)²+(Δa*)²+(Δb*)²}^{1/2}.

11. A color control method for executing the color control of a plurality of image outputting apparatuses individually installed at each site, by providing information regarding a corrected measured value of an output material outputted by each of the plurality of image outputting apparatuses, the corrected measured value being obtained by correcting a measured value of the output material based on a standard value of the measured value, the measured value having been measured by each of a plurality of calorimeters installed at each site, the color control method comprising the steps of:
transmitting a measured value of a color sample measured by the calorimeter installed at each site, a measured value of the output material measured subsequently to the color sample, and a measurement date of the output material, in each of the plurality of terminal apparatuses installed at each site; and in a control server connected to the plurality of terminal apparatuses via a network, the color control method-comprising the steps of:
previously storing a measured value of the color sample measured by a standard calorimeter as a standard value;
receiving the measured value of the color sample, the measured value of the output material, and the measurement date transmitted by the transmitting step;
deriving a correction formula according to the measured value of the color sample received and the standard value stored, in order to correct the measured value of the color sample received for approximating it to the standard value stored; and
creating information about a change over time of the corrected measured value of the output material based on the corrected measured value of the output material which has been received and corrected by the correction formula derived and the measurement date, so that the corrected measured value of the output material can be browsed from each of the plurality of terminal apparatuses.

12. The color control method of claim 11, wherein in each of the plurality of terminal apparatuses further comprises the steps of:
acquiring the information about a change over time of the corrected measured value of the output material created by the creating information step; and
displaying the information about a change over time of the corrected measured value of the output material acquired by the acquiring the information step.

13. The color control method of claim 11, wherein the information created in the creating information step is a graph showing a change over time of a density value or a colorimetric value of the corrected measured value, the graph representing the density value or the calorimetric value in a vertical axis and a measurement date in a horizontal axis.

14. The color control method of claim 13, wherein in each of the terminal apparatuses further comprising:
setting an allowed band/allowed value for setting an allowed band of the density value or an allowed value of the calorimetric value of the corrected measured value; and the creating information step, further comprising:
adding the allowed band of the density value or the allowed value of the calorimetric value on the graph representing the density value or the calorimetric value in a vertical axis and a measurement date in a horizontal axis.

15. The color control method of claim 14, wherein the step of setting an allowed band/allowed value comprising:
setting two steps of the allowed band of the density value or two steps of the allowed value of the calorimetric value of the corrected measured value; and the step of creating information further comprising:
adding the two steps of allowed band of the density value or the two steps of allowed value of the calorimetric value on the graph representing the density value or the calorimetric value in a vertical axis and a measurement date in a horizontal axis.

16. The color control method of claim 11, wherein the information created in the creating information step is a graph showing a change over time of a density value or a calorimetric value of the corrected measured value, the graph representing the density value or the calorimetric value in a vertical axis and a measurement date in a horizontal axis, wherein in each of the plurality of terminal apparatuses further comprising:
specifying display, as the information about a change over time of the corrected measured value of the output material, one of the graph representing the density value in a vertical axis and a measurement date in a horizontal axis and the graph representing the calorimetric value in a vertical axis and a measurement date in a horizontal axis, or both of the graphs.

17. The color control method of claim 16, wherein in each of the terminal apparatuses further comprising:
setting an allowed band/allowed value for setting an allowed band of the density value or an allowed value of the calorimetric value of the corrected measured value; and the step of creating information further comprising:
adding the allowed band of the density value or the allowed value of the calorimetric value on the graph representing the density value or the calorimetric value in a vertical axis and a measurement date in a horizontal axis.

18. The color control method of claim 17, wherein the step of setting an allowed band/allowed value sets comprising:
setting two steps of the allowed band of the density value or two steps of the allowed value of the calorimetric value of the corrected measured value; and the step of creating information comprising:
adding the two steps of allowed band of the density value or the two steps of allowed value of the calorimetric value on the graph representing the density value or the calorimetric value in a vertical axis and a measurement date in a horizontal axis.

19. The color control method of claim 13, wherein the calorimetric value comprises values of L*, a*, and b* in the CIE L*a*b* color system, and the change over time of the calorimetric value of the corrected measured value comprises values of ΔL*, Δa*, and Δb* which are the differences of the corrected measured value from the standard value of the calorimetric value, and value of ΔE expressed by ΔE={(ΔL*)²+(Δa*)²+(Δb*)²}^{1/2}.

20. The color control method of claim 17, wherein the calorimetric value comprises values of L*, a*, and b* in the CIE L*a*b* color system, and the change over time of the calorimetric value of the corrected measured value comprises values of ΔL*, Δa*, and Δb* which are the differences of the corrected measured value from the standard value of the colorimetric value, and value of ΔE expressed by ΔE={(ΔL*)²+(Δa*)²+(Δb*)²}^{1/2}.
